(19) United States
(12) Patent Application Publication
(10) Pub. No.: US 2008/0191609 A1
(43) Pub. Date: Aug. 14, 2008

(54) Illumination System Comprising a Red-Emitting Ceramic Luminescence Converter

(75) Inventors: Peter J. Schmidt, Aachen (DE); Joerg Meyer, Aachen (DE); Hans-Helmut Bechtel, Roetgen (DE); Theo Arnold Kop, Amsterdam (NL)

Correspondence Address: PHILIPS ELECTRONICS NORTH AMERICA CORPORATION;INTELLECTUAL PROPERTY & STANDARDS, 370 W. TRIMBLE ROAD MS 91/MG, SAN JOSE, CA, 95131, US

(73) Assignee: KONINKLIJKE PHILIPS ELECTRONICS N.V., EINDHOVEN (NL)

(21) Appl. No.: 11/911,677

(22) PCT Filed: Apr. 13, 2006
(86) PCT No.: PCT/IB06/51164

§ 371 Date: Oct. 16, 2007

(30) Foreign Application Priority Data
Apr. 19, 2005 (EP) 05103125.0

(51) Int. Cl. H01J 1/63; C01F 17/00

(52) U.S. Cl. 313/503; 423/263

(57) ABSTRACT

An illumination system, comprising a radiation source and a monolithic ceramic luminescence converter comprising at least one phosphor capable of absorbing a part of light emitted by the radiation source and emitting light of wavelength different from that of the absorbed light; wherein said at least one phosphor is an europium(III)-activated rare earth metal sesquioxide of general formula (Y_{Y-x}-XEₓ)_{2-z}(EU₁₋ₐ-3Aₐ)_{z}, wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1 can provide light sources having high luminosity and color-rendering index, especially in conjunction with a light emitting diode as a radiation source. The invention is also concerned with an amber to red-emitting a monolithic ceramic luminescence converter comprising an europium(III)-activated rare earth metal sesquioxide of general formula (Y₁₋ₓ-REₓ)_{2-z}O₃:(Eu₁₋ₐAₐ)_{Z}, wherein RE is selected from the group of gadolinium, scandium, and lutetium, A is selected from the group of dysprosium, samarium, thulium, and erbium, 0≦x<1, 0.001≦z≦; and 0≦a<1.

### BACKGROUND OF THE INVENTION

The present invention generally relates to an illumination system comprising a radiation source and a ceramic luminescence converter. The invention also relates to a ceramic luminescence converter for use in such illumination system.

More particularly, the invention relates to an illumination system and a ceramic luminescence converter for the generation of specific, colored light, including white light, by luminescent down conversion and additive color mixing based an a ultraviolet or blue radiation emitting radiation source. A light-emitting diode as a radiation source is especially contemplated.

Today light emitting illumination systems comprising visible colored light emitting diodes as radiation sources are used single or in clusters for all kind of applications where rugged, compact, lightweight, highly efficient, long-living, low voltage sources of white or colored illumination are needed.

Such applications comprise inter alia illumination of small LCD displays in consumer products such as cellular phones, digital cameras and hand held computers. Pertinent uses include also status indicators on such products as computer monitors, stereo receivers, CD players, VCRs, and the like. Indicators are also found in systems such as instrument panels in aircraft, trains, ships, cars, etc.

Multi-color combinations of pluralities of visible colored light emitting LEDs in addressable arrays containing hundreds or thousands of LED components are found in large area displays such as full color video walls and also as high brightness large-area outdoor television screens. Arrays of amber, red, and blue-green emitting LEDs are also increasingly being used as traffic lights or in effect lighting of buildings.

Conventional visible colored light emitting LEDs, however, are typically subject to low yield and are considered difficult to fabricate with uniform emission characteristics from batch to batch. The LEDs can exhibit large wavelength variations across the wafer within a single batch, and in operation can exhibit strong wavelength and emission variations with operation conditions such as drive current and temperature.

Therefore, when generating white light with an arrangement comprising visible colored light emitting diodes, there has been such a problem that white light of the desired tone cannot be generated due to variations in the tone, luminance and other factors of the visible colored light emitting diodes.

It is known to convert the color of light emitting diodes emitting in the UV to blue range of the electromagnetic spectrum by means of a luminescent material comprising a phosphor to provide a visible white or colored light illumination.

Phosphor-converted “white” LED systems have been based in particular on the dichromatic (BY) approach, mixing yellow and blue colors, in which case the yellow secondary component of the output light may be provided by a yellow phosphor and the blue component may be provided by a phosphor or by the primary emission of a blue LED.

Likewise white illumination systems have been based on the trichromatic (RGB) approach, i.e. on mixing three colors, namely red, green and blue, in which case the red and green component may be provided by a phosphor and the blue component by the primary emission of a blue-emitting LED.

As recent advances in light-emitting diode technology have yielded very efficient light-emitting diodes emitting in the near UV to blue range, today a variety of colored and white-emitting phosphor converted light emitting devices are on the market, challenging traditional incandescent or fluorescent lighting.

US20040233664 A1 discloses an illumination system utilizing multiple wavelength light recycling. The illumination system has a light source and a wavelength conversion layer within a light-recycling envelope. The light source is a light-emitting diode or a semiconductor laser. The wavelength conversion layer is comprised of a powdered phosphor material, a quantum dot material, a luminescent dopant material or a plurality of such materials. Powdered phosphor materials are typically optical inorganic materials doped with ions of lanthanide elements or, alternatively, ions such as chromium, titanium, vanadium, cobalt or neodymium.

Typically, the prior art phosphor converted light emitting devices utilize an arrangement in which a semiconductor chip having a LED thereon is covered by a wavelength conversion layer of epoxy resin with embedded pigment particles of one or more conversion phosphor. These phosphor particles convert the UV/blue radiation emitted by the LED to white or colored light as described above.

However, it has been a problem in prior art illumination systems comprising microcrystalline phosphor powders that they cannot be used for many applications because they have a number of problems.

First, the deposition of a wavelength conversion layer of uniform thickness is difficult. Since color uniformity requires a uniform thickness, color uniformity is also difficult to guarantee. In areas where the layer is thicker, the light appears in another hue of white as in sections having a thinner layer.

Second, the optical properties of wavelength conversion layers comprising pigment particles depend strongly on the materials utilized for the layer.

Only wavelength conversion layers containing particles that are much smaller than the wavelengths of visible light and that are dispersed in a transparent host material are highly transparent or translucent with only a small amount of light scattering. Wavelength conversion layers that contain particles that are approximately equal to or larger than the wavelengths of visible light will usually scatter light strongly. Such materials will be partially reflecting, leading to lower light extraction efficiency.

Third, if the wavelength conversion layer is partially reflecting, it is preferred that the layer be made thin enough so that it transmits at least part of the light incident upon the layer. But within thin layers the particles tend to agglomerate, and hence, providing a uniform layer with particles of a homogeneous distribution is difficult.

### SUMMARY OF THE INVENTION

It is therefore an object of the present invention to provide an illumination system for generating of white light, which has a suitable light extraction efficiency and transparency together with true color rendition.

According to another object of the invention an illumination system for generating of amber to red light is provided.

Thus according to one aspect of the invention the present invention provides an illumination system, comprising a radiation source and a monolithic ceramic luminescence converter comprising at least one phosphor capable of absorbing a part of light emitted by the radiation source and emitting light of wavelength different from that of the absorbed light; wherein said at least one phosphor is an europium(III)-activated rare earth metal sesquioxide of general formula (Y₁₋ₓREₓ)_{2-z}O₃:(Eu₁₋ₐAₐ)_{z}, wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1.

It has been known previously that a phosphor pigment comprising yttrium oxide with an activator of europium will meet the color and stability criteria of phosphor converted LEDs, but there existed tremendous difficulties with regard to the adhesion strength of this phosphor to any substrate, owing to the poor control over the particle sizes that could be produced with this material. The monolithic ceramic luminescence converter according to the invention offers equivalent performance to the polycrystalline oxide phosphor pigment but without the adhesion problems.

Also, as the monolithic ceramic luminescence converter is translucent, it does not impede the transmission of light and scattering of transient light is minimized.

The monolithic ceramic luminescence converter is easily machined to a uniform thickness, so the color conversion effect is the same across the surface, providing a more uniform composite light than the prior art devices.

Preferably said radiation source is a light-emitting diode.

In the embodiments of the invention, when the amber to red light-emitting phosphor of general formula (Y₁₋ₓREₓ)_{2-z}O₃:(Eu₁₋ₐAₐ)_{z}, wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1 is provided as a monolithic ceramic luminescence converter together with a light emitting diode, the resulting phosphor converted light emitting device emits amber to red light at a high luminance.

To reduce losses by total reflection at the interface between the monolithic ceramic luminescence converter and the substrate of the light emitting diode the illumination system may comprise an interface layer attached to said light-emitting diode and said monolithic ceramic luminescence converter.

In a preferred embodiment the interface layer comprises a ceramic material, selected from the group of alumina Al₂O₃, TiO₂ and yttria Y₂O₃.

In another embodiment the interface layer may comprise a glass.

According to one embodiment of the invention said monolithic ceramic luminescence converter is a first luminescence converter element, further comprising one or more second luminescence converter elements.

The second luminescence converter element may be a coating layer, comprising a second resin-bonded polycrystalline phosphor pigment as luminescent material. Otherwise the second luminescence converter element may be a second monolithic ceramic luminescence converter, comprising a second phosphor.

When the red light-emitting monolithic ceramic luminescence converter of the invention is provided along with further luminescence converters such as a green light-emitting phosphor e.g. BaMgAl₁₀O₁₇:Eu,Mn, Zn₂GeO₄:Mn or the like, and a blue light-emitting phosphor e.g. BaMgAl₁₀O₁₇:Eu, (Sr,Ca,Ba)₅ (PO₄)₃ Cl:Eu or the like, the resulting light emitting device emits white or intermediate colored light at a high luminance.

In any of these light emitting devices, it is possible to add as a further luminescence converter a second red light-emitting phosphor such as (Sr_{1-x-y}CaₓBa_{y})₂Si₅N₈:Eu, wherein 0≦x≦1 and 0≦y≦1; (Sr_{1-x-y}CaₓBa_{y})₂Si₅₋ₓAlₓN₈₋ₓOₓ:Eu, wherein 0≦x≦1 and 0≦y≦1; and (Sr₁₋ₓCaₓ)S:Eu, wherein 0≦x≦1 or the like.

According to another aspect of the invention a monolithic ceramic luminescence converter comprising at least one phosphor capable of absorbing a part of light emitted by the radiation source and emitting light of wavelength different from that of the absorbed light; wherein said at least one phosphor is an europium(III)-activated rare earth metal sesquioxide of general formula (Y₁₋ₓREₓ)_{2-z}O₃:(Eu₁₋ₐAₐ)_{z}, wherein RE is selected from the group of gadolinium, scandium, and lutetium, A is selected from the group of bismuth, antimony, dysprosium, samarium, thulium, and erbium, 0≦x<1, 0.001≦z≦0.02; and 0≦a<1 is provided.

Translucency and/or transparency, high density, low specific surface area—all these properties make the monolithic ceramic luminescence converters superior to polycrystalline phosphor pigments.

Such converter is not only effective, as it is a good converter for high-energy radiation, such as radiation in the UV to blue range of the electromagnetic spectrum. It is also effective, as it is a good transmitter of the light energy that results from the conversion of the high-energy radiation input. Otherwise the light would be absorbed in the material and the overall conversion efficiency suffers.

### DETAILED DESCRIPTION OF THE INVENTION

Monolithic Ceramic Luminescence Converter The present invention focuses on a monolithic ceramic luminescence converter (CLC) comprising an europium(III)-activated rare earth metal sesquioxide of general formula (Y₁₋ₓREₓ)_{2-z}O₃:(Eu₁₋ₐAₐ)_{z}, wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1 in any configuration of an illumination system comprising a source of primary radiation, including, but not limited to discharge lamps, fluorescent lamps, LEDs, Laser Diodes, OLEDs and X-ray tubes. As used herein, the term “radiation” encompasses radiation in the UV, IR and visible regions of the electromagnetic spectrum.

In general, a monolithic ceramic luminescence converter is a ceramic body, which emits electromagnetic radiation in the visible or near visible spectrum when stimulated by high-energy electromagnetic photons.

A monolithic ceramic luminescence converter is characterized by its typical microstructure. The microstructure of a monolithic ceramic luminescence converter is polycrystalline, i.e. an irregular conglomerate of cryptocrystalline, microcrystalline or nanocrystalline crystallites. Crystallites are grown to come in close contact and to share grain boundaries. Macroscopically the monolithic ceramic seems to be isotropic, though the polycrystalline microstructure may be easily detected by SEM (scanning electron microscopy).

The monolithic ceramic luminescence converter may eventually contain second phases at the grain boundaries of its crystallites that change the light scattering properties of the ceramic. The second phase material may be crystalline or vitreous.

Due to their monolithic polycrystalline microstructure ceramic luminescence converters are transparent or have at least high optical translucency with low light absorption.

### CLC Comprising Europium-Activated Sesquioxide Phosphor

The monolithic ceramic luminescence converter according to the invention comprising as a luminescent material an europium(III)-activated rare earth metal sesquioxide of general formula (Y₁₋ₓREₓ)_{2-z}O₃:(Eu₁₋ₐAₐ)_{z}, wherein RE is selected from the group of gadolinium, scandium, and lutetium or combinations thereof, A is selected from the group of bismuth, antimony, dysprosium, samarium, thulium, and erbium or combinations thereof. The values of x and a range from zero to less than 1, z ranges from 0.001 to 0.2.

Such a monolithic ceramic luminescence converter has a high degree of physical integrity, which property renders the material useful for machining, structuring and polishing to improve light extraction and enable light guiding effects.

The new amber to red emitting monolithic ceramic luminescence converter matches every single ideal requirement for use in illumination systems, i.e.

Strong amber to red emission

High quantum efficiency

Sensitivity to both short and long-wave UV stimulation

Efficient at high operating temperatures

Stable throughout very long operating lifetimes

The phosphor of general formula (Y₁₋ₓREₓ)_{2-z}O₃:(Eu₁₋ₐAₐ)_{z}, wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1 is an amber to red emitting and very efficient phosphor.

This class of phosphor material is based on europium(III)-activated luminescence of a sesquioxide of yttrium or of yttrium together with a rare earth metal selected from the group of gadolinium, scandium, and lutetium or combinations thereof.

The phosphor comprises a host lattice and dopant ions. The host lattice has a crystal structure known to the expert as the C-structure, derivable from the basic CaF2 crystal structure type, wherein all cations are octahedrically surrounded by oxygen.

As dopant europium is used either alone or in combination with co-activators selected from the group of bismuth, antimony, dysprosium, samarium, thulium, and erbium or combinations thereof.

The proportion z of europium(III) alone or in combination with a co-activator is preferably in a range of 0.001<z<0.2. When the proportion z is lower, luminance decreases because the number of excited emission centers of photoluminescence due to europium(III)-cations decreases and, when the fraction z is greater than 0.2, concentration quenching occurs. Concentration quenching refers to the decrease in emission intensity that occurs when the concentration of an activation agent added to increase the luminance of the luminescent material is increased beyond an optimum level.

These europium(III)-activated yttrium rare earth metal sesquioxide phosphors are responsive to more energetic portions of the electromagnetic spectrum than the visible portion of the spectrum.

In particular, the monolithic ceramic luminescence converters according to the invention are especially excitable by UV-radiation that has such wavelengths as 250 to 290 nm, but contrary to the powder pigment phosphors of the same composition are also excited with high efficiency by radiation emitted by a UVA to blue light-emitting component having a wavelength from 380 to 420 nm, see FIG. 6. Such a sharp excitation band, as it is recognizable in FIG. 6, proves that these are absorption peaks due to f-f transitions of Eu(III).

Since the excitation wavelength of the red light emitting monolithic ceramic luminescence converter is positioned in the range between long-wavelength ultraviolet and short-wavelength visible light (380-420 nm), the light of wavelength within this range can be converted to amber to red light.

Thus the luminescent material of the monolithic ceramic luminescence converter has ideal characteristics to be used in combination with a UVA/blue light of nitride semiconductor light emitting diode as a source of primary radiation.

Specification of a monolithic ceramic luminescence converter comprising Y₂O₃:Eu:

| Chemical symbol | Y₂O₃: Eu |
|---|---|
| Chromaticity Coordinates | x = 0.654 ± 0.003 |
| | y = 0.345 ± 0.003 |
| Brightness % | ≧99 |
| True density (g/cm³) | 5.1 ± 0.1 |
| Main peak of emission spectrum nm | 611 |

The emission peak of a monolithic ceramic luminescence converter comprising a phosphor of the basic Y₂O₃:Eu composition centers at around 611 nm, in the amber range of the visible light.

Owing to the spectral sensitivity of the human eye the lumen equivalent of the Eu(III) emission at 611 nm is relatively high while the color point is still in the red region of the 1931 CIE chromaticity diagram. Due to the combination of this effect, and the fact that the new monolithic ceramic luminescence converter has a much lower absorption of other wavelengths, the total luminous efficacy of a phosphor converted light emitting device comprising a monolithic ceramic luminescence converter can be increased in comparison to a device comprising a powder phosphor pigment.

### Manufacturing of the Monolithic Ceramic Luminescence Converter

The monolithic ceramic luminescence converter according to the invention is manufactured by preparing in a first step a luminescent microcrystalline phosphor powder material and in a second step isostatically pressing the microcrystalline material into pellets and sintering the pellets at an elevated temperature and for a period of time sufficient to allow compaction to an optically translucent body.

The method for producing a microcrystalline phosphor powder of the present invention is not particularly restricted, and it can be produced by any method, which will provide phosphors according to the invention.

A preferred process for producing a phosphor according to the invention is referred to as

liquid precipitation. In this method, a solution, which includes soluble phosphor precursors, is chemically treated to precipitate phosphor particles or phosphor precursor particles. These particles are typically calcined at an elevated temperature to produce the phosphor compound.

E.g., a useful method is known from U.S. Pat. No. 6,677,262, which discloses a method for preparing rare earth oxides by maintaining an aqueous solution of water-soluble rare earth salts and urea, the urea in an initial concentration of up to 50 g/liter, at a temperature of at least 80° C., while monitoring the urea concentration and adding urea to the aqueous solution so as to keep the concentration of urea substantially constant to the initial concentration, thereby forming a basic rare earth carbonate, and firing the basic rare earth carbonate to produce the rare earth oxides.

A series of compositions of general formula europium(III)-activated yttrium rare earth metal sesquioxide of general formula (Y₁₋ₓREₓ)_{2-z}O₃:(Eu₁₋ₐAₐ)_{z}, wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1 can be manufactured by this method.

In a specific embodiment amber to red emitting particles of europium(III)-activated yttrium sesquioxide are prepared as monodisperse phosphor powders by the following technique: In a 40 l glass lined vessel 1.35 l of a 0.5 M YCl₃ solution in deionized water, 33.46 g Eu(NO₃)₃*6H₂O and 1.4625 kg urea are dissolved in water while stirring vigorously. Further water is added to a final volume of 30 l. The solution is heated to boiling and after the first turbidity has occurred, it is heated for an additional period of 2 h. The precipitate is collected on a funnel and washed to remove chloride. It is then dried and subsequently calcined at 800° C. for 2 h. The resulting precursor powder consists of spherical particles with an average size of 250 nm. The phosphor pigments were characterized by powder X-ray diffraction (Cu, Kα-line), which showed, that the desired oxides with the desired crystal structure had been formed.

Such phosphor powder materials can also be made by the solid-state method. In this process, the phosphor precursor materials are prepared separately and are mixed in the solid state and are heated so that the precursors react and form a powder of the phosphor material.

In yet another method, phosphor powder particle precursors or phosphor particles are dispersed in slurry, which is then spray dried to evaporate the liquid. The spray-dried powder is then converted to a phosphor by sintering at an elevated temperature to crystallize the powder and to form the microcrystalline phosphor powders. The fired powder is then lightly crushed and milled to recover phosphor particles of desired particle size.

The fine-grained microcrystalline phosphor powders obtained by these methods are used to prepare a monolithic ceramic luminescence converter according to the invention. To this aim a suitable phosphor powder is subjected to a very high pressure either in combination with a treatment at elevated temperature or followed by a separate heat treatment. Isostatic pressing is preferred.

Especially preferred is a hot isostatic pressure treatment or otherwise cold isostatic pressure treatment followed by sintering. A combination of cold isostatic pressing and sintering followed by hot isostatic pressing may also be applied.

Careful supervision of the densification process is necessary to control grain growth and to remove residual pores.

Pressing and heat treatment of the phosphor material produces a monolithic ceramic body, which is easily sawed, machined and polished by current metallographic procedures. The monolithic polycrystalline ceramic material can be sawed into wafers, which are 1 millimeter or less in width. Preferably, the ceramic is polished to get a smooth surface and to impede diffuse scattering caused by surface roughness.

In a specific embodiment for manufacturing transparent monolithic europium(III)-activated yttria ceramic luminescence converters the fine-grained phosphor powder is first processed to green (non-fired) bodies by known ceramic techniques: The powder is ground in an agate mortar with 10% of binder (5% polyvinyl alcohol in water). It is passed through a 500 μm sieve and pressed to green bodies by use of a powder compacting tool and subsequent cold isostatic pressing at 3200 bar. The ceramic green (=non-fired) bodies are sintered to transparent monolithic ceramics in vacuum at 1700° C. Luminous output may be improved through an additional annealing step at slightly lower temperatures in flowing argon. After cooling down to room temperature the oxide ceramics obtained were sawed into wavers. These wavers were ground and polished to obtain the final translucent ceramics.

The CLC microstructure features a statistical granular structure of crystallites forming a grain boundary network.

### Phosphor-Converted Illumination System Comprising Amber to Red-Emitting CLC

According to one aspect of the invention an illumination system, comprising a radiation source and a monolithic ceramic luminescence converter comprising at least one phosphor capable of absorbing a part of light emitted by the radiation source and emitting light of wavelength different from that of the absorbed light; wherein said at least one phosphor is an europium(III)-activated yttrium rare earth metal sesquioxide of general formula (Y₁₋ₓREₓ)_{2-z}O₃:(Eu₁₋ₐAₐ)_{z}, wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1 is provided.

While the use of the present monolithic ceramic luminescence converter is contemplated for a wide array of illumination systems, the present invention is described with particular reference to and finds particular application to illumination systems comprising radiation sources, which are preferably semiconductor optical radiation emitters and other devices that emit optical radiation in response to electrical excitation. Semiconductor optical radiation emitters include light emitting diode LED chips, light emitting polymers (LEPs), organic light emitting devices (OLEDs), polymer light emitting devices (PLEDs), etc.

Any configuration of an illumination system which includes a light-emitting diode or an array of light-emitting diodes and ceramic luminescence converter comprising a europium(III)-activated rare earth metal sesquioxide of general formula (Y₁₋ₓREₓ)_{2-z}O₃:(Eu₁₋ₐAₐ)_{z}, wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1 is contemplated in the present invention, preferably with addition of other well-known phosphors, which can be combined to achieve a specific color or white light when irradiated by a LED emitting primary UV or blue light as specified above.

Possible configurations of phosphor converted light emitting devices combining the monolithic ceramic luminescence converter and a light emitting diode or an array of light emitting diodes comprise lead frame-mounted LEDs as well as surface-mounted LEDs.

A detailed construction of one embodiment of such phosphor converted light emitting device comprising a light emitting diode and a monolithic ceramic luminescence converter shown in FIG. 1 will now be described.

FIG. 1 shows a schematic view of a lead-frame mounted type light emitting diode with a monolithic ceramic luminescence converter.

The light emitting diode element 1 placed within the reflection cup 3 is a small chip shaped in the form of a cube and has electrodes 5 provided at the top and backside surface thereof respectively. The backside electrode is bonded to the cathode electrode with conductive glue. The top electrode is electrically connected to the anode electrode via a bond wire 4.

A monolithic ceramic luminescence converter 2 configured as a plate is positioned into the reflection cup in that way, that most of the light, which is emitted from the light-emitting diode, enters the plate in an angle, which is almost perpendicular to the surface of the plate. To achieve this, a reflector is provided around the light-emitting diode in order to reflect light that is emitted from the light-emitting diode in directions untowardly the plate.

In operation, electrical power is supplied to the LED die to activate the die. When activated, the die emits the primary light, e.g. UV or visible blue light. A portion of the emitted primary light is completely or partially absorbed by the ceramic luminescence converter. The ceramic luminescence converter then emits secondary light, i.e., the converted light having a longer peak wavelength, primarily amber to red in a sufficiently broadband in response to absorption of the primary light. The remaining unabsorbed portion of the emitted primary light is transmitted through the ceramic luminescence converter, along with the secondary light.

The reflector directs the unabsorbed primary light and the secondary light in a general direction as output light. Thus, the output light is a composite light that is composed of the primary light emitted from the die and the secondary light emitted from the luminescent layer.

The color temperature or color point of the output light of an illumination system according to the invention will vary depending upon the spectral distributions and intensities of the secondary light in comparison to the primary light.

Firstly, the color temperature or color point of the primary light can be varied by a suitable choice of the light emitting diode.

Secondly, the color temperature or color point of the secondary light can be varied by a suitable choice of the specific phosphor composition in the ceramic luminescence converter.

It should be noted that multiple luminescence converting elements could also be utilized. For example, if a UV-emitting LED is utilized, two phosphors can be used to provide a light source that is perceived as being white by an observer. In this case, a second monolithic ceramic luminescence converter may be added. Otherwise a resin bonded luminescence converter may be added as a layer coating or an emitter package.

FIG. 2 shows a schematic view of a lead-frame mounted type light emitting diode with two luminescence converters. The light emitting diode element 1 placed within the reflection cup 3 is encased in a resin package 6 that is made of a transparent polymer material such as silicon or epoxy resin. The resin package may have a polycrystalline luminescence conversion material distributed throughout. The luminescence conversion material can be one or more luminescent material, such as a phosphor or a luminescent dye. The amber to red-emitting monolithic ceramic luminescence converter according to the invention is positioned on top of the resin package.

Often, light emitting diodes are fabricated on insulating substrates, such as sapphire, with both contacts on the same side of the device. Such devices may be mounted in a way that light is extracted either through the contacts, known as an epitaxy-up device, or through a surface of the device opposite the contacts, known as a flip chip device. FIG. 3 schematically illustrates a specific structure of a solid-state illumination system comprising a monolithic ceramic luminescence converter wherein the chip is packaged in a flip chip configuration on a substrate 7 with both electrodes contacting the respective leads without using bond wires. The LED die is flipped upside down and bonded onto a thermally conducting substrate 7. An amber to red-emitting monolithic ceramic luminescence converter according to the invention is attached to the top of the LED die.

A resin coating is formed over the exterior of the light emitting diode and the monolithic ceramic luminescence converter having dispersed therein a second polycrystalline luminescence converting material.

In operation, the light emitted by the light emitting diode is wavelength converted by the monolithic ceramic luminescence converter and mixed with the wavelength-converted light of the second luminescence converter to provide white or colored visible light.

FIG. 4 shows a schematic cross sectional view of a red lamp comprising a monolithic ceramic luminescence converter of the present invention positioned in the pathway of light emitted by light-emitting diodes with a flip chip arrangement.

FIG. 5 illustrates a schematic cross sectional view of multiple LEDs mounted on a board in combination with monolithic ceramic luminescence converters for use as a RGB display or light source.

### Phosphor Converted Light Emitting Device Comprising a Refractive Index Matched Interface Layer for Connecting of Monolithic Ceramic Luminescence Converter and LED Substrate

To reduce losses by total reflection at layer boundaries it is crucial to have a refractive index matched connection between the substrate of the light emitting diode and the monolithic ceramic color converter. Due to the big difference in thermal expansion coefficients (8.1*10⁻⁶ K⁻¹ for yttria and 5-6.7*10⁻⁶K⁻¹ for a sapphire substrate) sinter bonding by conventional methods is not possible. An alternative is to use a rapid thermal processor (RTP, i.e. an halogen lamp oven) for fast heating of the materials in a graphite box. As thermal equilibrium is never reached due to the extreme heat up rates (>10K s⁻¹) mechanical stress is minimized, which in turn leads to crack free sinter-bonding.

Bonding can also be realized via an intermediate Al₂O₃, TiO₂ or Y₂O₃-layer, which is prepared by a conventional sol-gel method. For this purpose a solution of an aluminum, titanium or yttrium alcoholate such as aluminum, titanium or yttrium isopropoxide in a solvent such as ethyleneglycolmonomethylether, toluene, alcohols or ethers is used for formation of the interstitial Al₂O₃, TiO₂ or Y₂O₃-layer. This solution is used to coat either the monolithic ceramic luminescence converter or the substrate of the light-emitting diode or both. The two materials are then connected and the interstitial layer is crystallized.

Further glass frits of high refractive index glasses (e.g. Schott LaSF 1.8/35) can be applied in between the substrate and the monolithic ceramic luminescence converter and through heating an interstitial glass layer is formed as a connection.

### The White Light-Emitting Phosphor-Converted Light Emitting Device

According to one aspect of the invention the output light of the illumination system comprising a radiation source, preferably a light emitting diode, and an amber to red emitting monolithic ceramic luminescence converter according to the invention may have a spectral distribution such that it appears to be “white” light.

The most popular prior art white phosphor converted LEDs consist of a blue emitting LED chip that is coated with a phosphor that converts some of the blue radiation to a complimentary color, e.g. a yellow to amber emission. Together the blue and yellow emissions produce white light.

White LEDs, which utilize a UV emitting chip and phosphors designed to convert the UV radiation to visible light are also known. Typically, three or more phosphor emission bands are required for producing white light.

### Blue/CLC White LED

(Dichromatic White Light Phosphor Converted Light Emitting Device Using Blue Emitting Light Emitting Diode)

In a first embodiment of a white-light emitting illumination system according to the invention the device can advantageously be produced by choosing the luminescent material of the monolithic ceramic luminescence converter such that a blue radiation emitted by a blue light emitting diode is converted into complementary wavelength ranges in the amber ranges of the electromagnetic spectrum, to form dichromatic white light.

Particularly good results are achieved with a blue-emitting LED whose emission maximum lies at 390 to 480 nm. An optimum has been found to lie at 395 nm, another one is at 467 nm, taking particular account of the excitation spectrum (FIG. 6) of the europium(III)-activated yttrium rare earth sesquioxides according to the invention.

Amber light is produced by means of the phosphor material of the monolithic ceramic luminescence converter, that comprises an europium(III)-activated rare earth metal sesquioxide of general formula (Y₁₋ₓREₓ)_{2-z}O₃:(Eu₁₋ₐAₐ)_{z}, wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1.

In operation a portion of the primary blue light emitted by the LED device passes through the monolithic ceramic luminescence converter without impinging on activator ions.

Another portion of the primary blue radiation emitted by the LED device impinges on the activator ions of the luminescence converter, thereby causing them to emit amber to red light. Thus part of a blue radiation emitted by a Al,In,Ga,N light emitting diode is shifted into the amber spectral region and, consequently, into a wavelength range which is complementarily colored with respect to the color blue. A human observer perceives the combination of blue primary light and the secondary amber to red light as white light.

(Trichromatic White Light Phosphor Converted Light Emitting Device Using Blue Emitting Light Emitting Diode)

In a second embodiment yielding white light emission with even higher color rendering is provided by using a blue-emitting LED and an amber to red emitting monolithic ceramic luminescence converter comprising europium(III)-activated yttrium rare earth metal sesquioxide together with additional red, yellow or green broad band emitter phosphor pigments admixed in a resin bonded encapsulation layer and thus covering the whole spectral range of visible white light.

Useful second phosphors and their optical properties are summarized in the following table 2.

TABLE 2

| Composition | λₘₐₓ [nm] | Color point x, y |
|---|---|---|
| (Ba₁₋ₓSrₓ)₂SiO₄: Eu | 523 | 0.272, 0.640 |
| SrGa₂S₄: Eu | 535 | 0.270, 0.686 |
| SrSi₂N₂O₂: Eu | 541 | 0.356, 0.606 |
| SrS: Eu | 610 | 0.627, 0.372 |
| (Sr_{1-x-y}CaₓBa_{y})₂Si₅N₈: Eu | 615 | 0.615, 0.384 |
| (Sr_{1-x-y}CaₓBa_{y})₂Si₅₋ₐAlₐN₈₋ₐOₐ: Eu | 615-650 | * |
| CaS: Eu | 655 | 0.700, 0.303 |
| (Sr₁₋ₓCaₓ)S: Eu | 610-655 | * |

* color point depending on the value of x

The luminescent materials may comprise two phosphors, e.g. the amber to red emitting monolithic ceramic luminescence converter according to the invention and a green phosphor selected from the group comprising (Ba₁_{_{—}}_{X}Srₓ)₂ SiO₄:Eu, wherein 0≦x≦1, SrGa₂S₄:Eu and SrSi₂N₂O₂:Eu in a resin bonded encapsulation layer.

Otherwise the luminescent materials may comprise three phosphors, e.g. the amber to red emitting monolithic ceramic luminescence converter, a red phosphor selected from the group (Ca₁₋ₓSrₓ) S:Eu, wherein 0≦x≦1 and (Sr_{1-x-y}BaₓCa_{y})₂Si₅₋ₐAlₐN₈₋ₐOₐ:Eu wherein 0≦a<5, 0<x≦1 and 0≦y≦1 and a yellow to green phosphor selected from the group comprising (Ba₁_{_{—}}_{X}Srₓ)₂ SiO₄:Eu, wherein 0≦x≦1, SrGa₂S₄:Eu and SrSi₂N₂O₂:Eu in a resin bonded encapsulation layer.

In operation one portion of the primary blue radiation emitted by the LED chip impinges on the activator ions of the luminescence converter, thereby causing the activator ions to emit amber to red light. This part of a blue radiation emitted emitting diode is shifted into the amber spectral region.

A second portion of the primary blue radiation emitted by the LED device passes through the monolithic ceramic luminescence converter and is shifted by the luminescent material in the resin coating into the green spectral region.

Still another part of blue radiation emitted by a light emitting diode passes the monolithic ceramic luminescence converter and the luminescent coating unaltered.

A human observer perceives the triad combination of blue primary light, and secondary amber light from the monolithic ceramic luminescence converter and secondary light of the yellow- to green emitting phosphor as white light.

The hue (color point in the CIE chromaticity diagram) of the white light thereby produced can be varied by a suitable choice of the phosphors in respect of mixture and concentration.

### UV/CLC White LED

(Dichromatic white phosphor converted light emitting device using UV-emitting light). In further embodiment, a white-light emitting illumination system according to the invention can advantageously be produced by choosing the luminescent material such that a UV radiation emitted by the UV radiation emitting diode is converted into complementary wavelength ranges, to form dichromatic white light.

Particularly good results are achieved with a UV-emitting LED whose emission maximum lies at 390 to 480 nm. An optimum has been found to lie at 395 nm, another one is at 467 nm, taking particular account of the excitation spectrum of the europium(III)-activated yttrium rare earth sesquioxides according to the invention.

In this embodiment, amber as well as blue light is produced by means of the luminescent materials. Amber light is produced by means of the monolithic ceramic luminescence converter that comprises a europium(III)-activated yttrium rare earth metal oxide phosphor. Blue light is produced by means of the luminescent materials that comprise a blue phosphor that may be selected from the group comprising BaMgAl₁ₒ0₁₇:Eu, Ba₅SiO₄(Cl,Br)₆:Eu, CaLn₂S₄:Ce, wherein Ln represents an lanthanide metal, and (Sr,Ba,Ca)₅(PO₄)₃Cl:Eu, in a resin bonded layer.

One portion of the primary radiation emitted by the LED device impinges on the activator ions in the monolithic ceramic luminescence converter, thereby causing the activator ions to emit amber light.

Another portion passes through the monolithic ceramic luminescence converter and is shifted by the luminescent material in the resin coating into the blue spectral region. A human observer perceives the combination of secondary blue and amber light, as white light.

(Trichromatic white phosphor converted light emitting device using UV emitting-LED). Yielding white light emission with even higher color rendering is possible by using blue and green broad band emitter phosphors covering the whole spectral range together with a UV emitting LED and a amber to red emitting monolithic ceramic luminescence converter.

The luminescent materials may be a blend of three phosphors, an amber to red europium(III)-activated yttrium rare earth sesquioxide provided as monolithic CLC, a blue phosphor selected from the group comprising BaMgAl₁ₒ0₁₇:Eu, Ba₅SiO₄(Cl,Br)₆:Eu, CaLn₂S₄:Ce and (Sr,Ba,Ca)₅(PO₄)₃Cl:Eu and a yellow to green phosphor selected from the group comprising (Ba₁_{_{—}}_{X}Srₓ)₂ SiO₄:Eu, wherein 0≦x≦1, SrGa₂S₄:Eu and SrSi₂N₂O₂:Eu.

The hue (color point in the CIE chromaticity diagram) of the white light thereby produced can in this case be varied by a suitable choice of the phosphors in respect of mixture and concentration.

### The Amber to Red Light-Emitting Phosphor-Converted Light Emitting Device

According to another aspect of the invention the output light of the illumination system comprising a radiation source and a red emitting monolithic ceramic luminescence converter may have a spectral distribution such that it appears to be amber to red light.

A monolithic ceramic luminescence converter comprising europium(III)-activated rare earth metal sesquioxide of general formula (Y₁₋ₓREₓ)_{2-y}O₃:(Eu₁₋ₐAₐ), wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1, as phosphor is particularly well suited as a amber to red component for stimulation by a primary UVA or blue radiation source such as, for example, an UVA-emitting LED or blue-emitting LED.

It is possible thereby to implement a phosphor converted light emitting device emitting in the amber to red regions of the electromagnetic spectrum.

Particularly good results are achieved with a UV-emitting LED whose emission maximum lies at 390 to 480 nm. An optimum has been found to lie at 395 nm, another one is at 467 nm, taking particular account of the excitation spectrum of europium-activated yttrium rare earth metal sesquioxide.

In another embodiment, amber to red-light emitting illumination system according to the invention can advantageously be produced by choosing as a radiation source a blue emitting diode and converting the blue radiation entirely into monochromatic amber to red light by a monolithic ceramic luminescence converter according to the invention.

The color output of the LED-CLC system is very sensitive to the thickness of the monolithic ceramic luminescence converter. If the converter thickness is high, then a lesser amount of the primary blue LED light will penetrate through the converter. The combined LED-CLC system will then appear amber to red, because it is dominated by the amber to red secondary light of the monolithic ceramic luminescence converter. Therefore, the thickness of the monolithic ceramic luminescence is a critical variable affecting the color output of the system.

### DESCRIPTION OF THE DRAWINGS

FIG. 1 shows a schematic side view of a dichromatic white LED lamp comprising a ceramic luminescence converter of the present invention positioned in the pathway of light emitted by a light-emitting diode lead-frame structure.

FIG. 2 shows a schematic side view of a trichromatic white LED lamp comprising a ceramic luminescence converter of the present invention positioned in the pathway of light emitted by a light-emitting diode lead-frame structure.

FIG. 3 shows a schematic side view of a trichromatic white LED lamp comprising a ceramic luminescence converter of the present invention positioned in the pathway of light emitted by a light-emitting diode flip chip structure.

FIG. 4 shows a schematic side view of a dichromatic green lamp comprising a ceramic luminescence converters of the present invention positioned in the pathway of light emitted by an light-emitting diode flip chip structure.

FIG. 5 shows a schematic side view of a RGB display comprising ceramic luminescence converters of the present invention positioned in the pathway of light emitted by a light-emitting diode flip chip structure.

FIG. 6 the excitation pattern of ceramic luminescence converter according to the invention in comparison to a polycrystalline phosphor pigment comprising Y₂O₃:Eu.

FIG. 7 the emission pattern of ceramic luminescence converter according to the invention in comparison to a polycrystalline phosphor pigment comprising Y₂O₃:Eu.

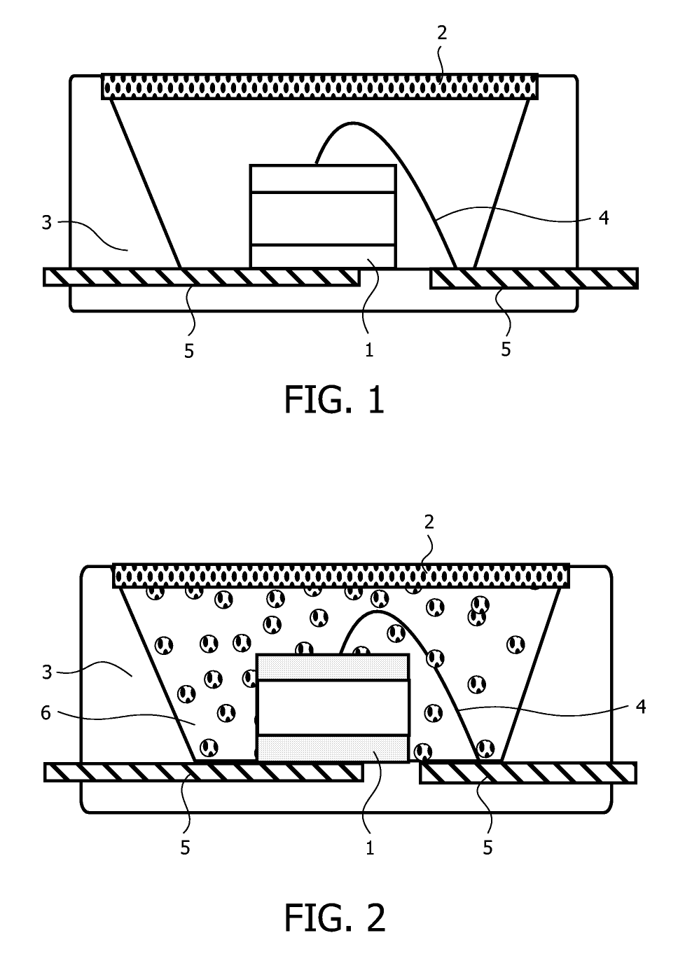

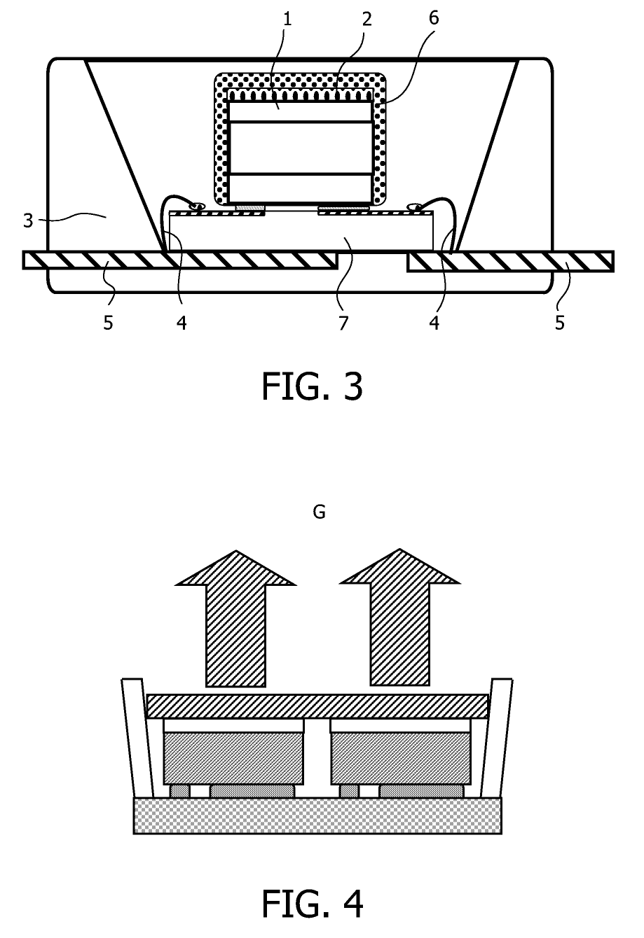

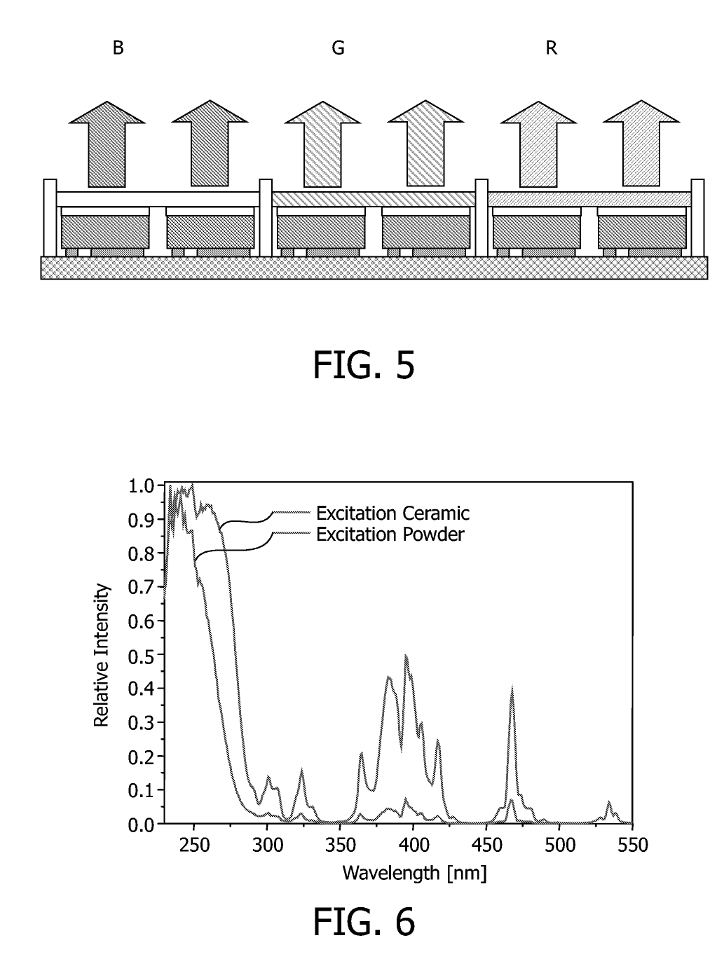

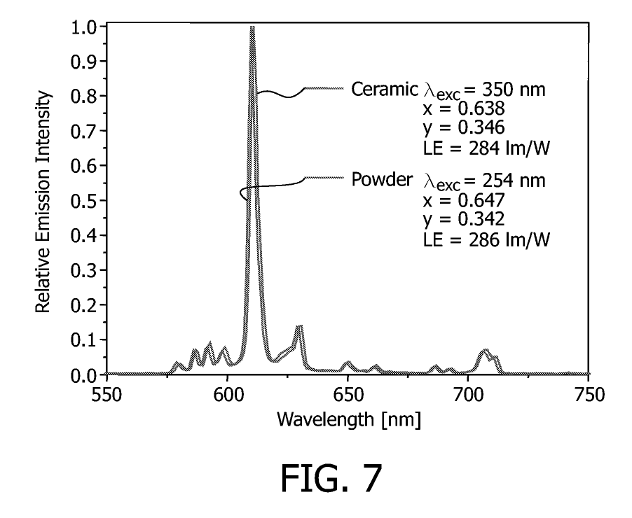

### LIST OF NUMERALS

1 Light emitting diode
2 Monolithic ceramic luminescence converter
3 Reflector
4 Wirebond
5 Electrodes
6 Phosphor coating
7 Lead frame

1. Illumination system, comprising a radiation source and a monolithic ceramic luminescence converter comprising at least one phosphor capable of absorbing a part of light emitted by the radiation source and emitting light of wavelength different from that of the absorbed light; wherein said at least one phosphor is an europium(III)-activated rare earth metal sesquioxide of general formula (Y₁₋ₓREₓ)_{2-y}O₃:(Eu₁₋ₐAₐ) wherein RE is selected from the group of gadolinium, scandium, and lutetium, A is selected from the group of bismuth, antimony, dysprosium, samarium, thulium, and erbium, 0≦x<1, 0.001≦z≦0.2; and 0≦a<1.

2. Illumination system according to claim 1, wherein said radiation source is a light-emitting diode.

3. Illumination system according to claim 2, comprising an interface layer attached to said light-emitting diode and said monolithic ceramic luminescence converter.

4. Illumination system according to claim 3, wherein the interface layer comprises a ceramic material, selected from the group of alumina Al₂O₃, titania TiO₂ and yttria Y₂O₃.

5. Illumination system according to claim 3, wherein the interface layer comprises a glass.

6. Illumination system according to claim 1, wherein said monolithic ceramic luminescence converter is a first luminescence converter element, further comprising one or more second luminescence converter elements.

7. Illumination system according to claim 3, wherein the second luminescence converter element is a coating, comprising a resin-bonded phosphor pigment.

8. Illumination system according to claim 3, wherein the second luminescence converter element is a second monolithic ceramic luminescence converter, comprising a second phosphor.

9. Monolithic ceramic luminescence converter comprising at least one phosphor capable of absorbing a part of light emitted by the radiation source and emitting light of wavelength different from that of the absorbed light; wherein said at least one phosphor is an europium(III)-activated rare earth metal sesquioxide of general formula (Y₁₋ₓREₓ)_{2-y}O₃:(Eu₁₋ₐAₐ), wherein RE is selected from the group of gadolinium, scandium, and lutetium, A is selected from the group of dysprosium, samarium, thulium, and erbium, bismuth, antimony, dysprosium, samarium, thulium, and erbium, 0≦x<1, 0.001≦z≦0.2; and 0≦a<1.
